(19) United States
(12) Patent Application Publication
(10) Pub. No.: US 2024/0129211 A1
(43) Pub. Date: Apr. 18, 2024

(54) Apparatus for Predicting Traffic Speed and Method Thereof

(71) Applicants: Hyundai Motor Company, Seoul (KR); Kia Corporation, Seoul (KR); IUCF-HYU (Industry-University Cooperation Foundation Hanyang University), Seoul (KR)

(72) Inventors: Nam Hyuk Kim, Seoul (KR); Tae Heon Kim, Seoul (KR); Sung Hwan Park, Seoul (KR); Sang Wook Kim, Seoul (KR); Jun Ho Song, Seoul (KR); Ji Won Son, Seoul (KR); Dong Hyuk Seo, Seoul (KR)

(21) Appl. No.: 18/178,855

(22) Filed: Mar. 6, 2023

(30) Foreign Application Priority Data
Oct. 12, 2022 (KR) 10-2022-0130688

(51) Int. Cl. H04L 43/062; H04L 41/16; H04L 43/028

(52) U.S. Cl. CPC H04L 43/062; H04L 41/16; H04L 43/028

(57) ABSTRACT

An apparatus for predicting a traffic speed and a method thereof are provided. The apparatus includes an input device that receives traffic speed sequences of a plurality of links and a controller that detects a spatio-temporal relationship between traffic speeds of the plurality of links and predicts a future traffic speed of a target link based on the spatio-temporal relationship between the traffic speeds of the plurality of links.

### CROSS-REFERENCE TO RELATED APPLICATIONS

This application claims the benefit of priority to Korean Patent Application No. 10-2022-0130688, filed in the Korean Intellectual Property Office on Oct. 12, 2022, the entire contents of which are incorporated herein by reference.

### TECHNICAL FIELD

The present disclosure relates to an apparatus for predicting traffic speed and a method thereof.

### BACKGROUND

In general, the artificial neural network (ANN) is one field of artificial intelligence, which is an algorithm allowing a machine to simulate and learn the human neural structure. Recently, the ANN has been applied to image recognition, speed recognition, natural language processing, and the like to show excellent effects. The ANN is composed of an input layer for receiving an input, a hidden layer for actually performing learning, and an output layer for returning the result of calculation. A plurality of hidden layers are referred to as a deep neural network (DNN). The DNN is a kind of ANN.

The ANN allows a computer to learn on its own based on data. When solving a certain problem using the ANN, what needs to be prepared is an appropriate ANN model and data to be analyzed. An ANN model for solving a problem is learned based on data. Prior to learning the model, there is a need for a work of dividing data into two types. In other words, data should be divided into a train dataset and a validation dataset. The train dataset is used to train the model, and the validation dataset is used to validate performance of the model.

There are several reasons for validating an ANN model. An ANN developer corrects a hyper parameter of the model based on the result of validating the model to tune the model. Furthermore, the model is validated to select which model is suitable among several models. A description will be given in detail of the reason why model validation is necessary.

First, it is to predict accuracy. The purpose of the ANN is to achieve good performance on out-of-sample data which is not used for training. Therefore, after creating the model, it is essential to verify how well the model will perform on out-of-sample data. However, because the model should not be validated using the train dataset, accuracy of the model should be measured using the validation dataset independent of the train dataset.

Secondly, the model is turned to enhance performance of the model. For example, overfitting may be prevented. The overfitting refers to when the model is overtrained on the train dataset. As an example, when training accuracy is high and when validation accuracy is low, the possibility of overfitting may be suspected. This may be identified in detail by means of a training loss and a validation loss. When the overfitting occurs, the overfitting should be prevented to enhance accuracy of validation. The overfitting may be prevented using a method such as regularization and dropout.

Meanwhile, an existing technology for predicting a traffic speed predicts a future traffic speed of a target link based on a historical traffic speed of the target link and a historical traffic speed of a surrounding link. At this time, because a user subjectively determines a certain number of surrounding links, a traffic speed is not predicted to have high accuracy.

Thus, another existing technology for extracting a surrounding link with high relationship with a target link and predicting a future traffic speed of the target link based on a historical traffic speed of the target link and a historical traffic speed of the surrounding link is proposed. However, because this only considers the relationship between the target link and the surrounding link and does not consider temporal causality between the traffic speed of the target link and the traffic speed of the surrounding link, a traffic speed is not predicted to have high accuracy.

Details described in the background art are written to increase the understanding of the background of the present disclosure, which may include details rather than an existing technology well known to those skilled in the art.

### SUMMARY

Embodiments of the present disclosure relates to technologies of predicting a traffic speed of the road based on an artificial neural network (ANN) model.

Embodiments of the present disclosure has been made to solve the above-mentioned problems occurring in the prior art while advantages achieved by the prior art are maintained intact.

An embodiment of the present disclosure provides an apparatus for predicting a traffic speed to collect historical traffic speed sequences of a plurality of links, detect a spatio-temporal relationship between traffic speeds of the plurality of links, and predict a future traffic speed of a target link based on the spatio-temporal relationship between the traffic speeds of the plurality of links to predict the traffic speed of the target link to have high accuracy and a method thereof.

Another embodiment of the present disclosure provides an apparatus for predicting a traffic speed to predict a future traffic speed of a target link with regard to temporal causality between a traffic speed of a target link and a traffic speed of a surrounding link as well as a relationship between the target link and the surrounding link to predict the traffic speed of the target link to have high accuracy and a method thereof.

Another embodiment of the present disclosure provides an apparatus for predicting a traffic speed to predict a traffic speed of a target link based on a spatio-temporal graph attention (ST-GAT) model and input historical traffic speed sequences of a plurality of links to the ST-GAT model to predict the traffic speed of the target link to have high accuracy and a method thereof.

The purposes of the present disclosure are not limited to the aforementioned purposes, and any other purposes and advantages not mentioned herein will be clearly understood from the following description and may more clearly known by an embodiment of the present disclosure. Furthermore, it may be easily seen that purposes and advantages of the present disclosure may be implemented by means indicated in claims and a combination thereof.

According to an embodiment of the present disclosure, an apparatus for predicting a traffic speed may include an input device that receives traffic speed sequences of a plurality of links and a controller that detects a spatio-temporal relationship between traffic speeds of the plurality of links and predicts a future traffic speed of a target link based on the spatio-temporal relationship between the traffic speeds of the plurality of links.

In an embodiment of the present disclosure, the controller may extract features of the traffic speeds of the plurality of links, may classify the features of the traffic speeds of the plurality of links for each link, and may predict the future traffic speed of the target link based on the features of the traffic speeds, the features being classified for each link.

In an embodiment of the present disclosure, the controller may input the features of the traffic speeds, the features being classified for each link, to a fully connected (FC) layer corresponding to each link and may predict a future traffic speed sequence of each link.

In an embodiment of the present disclosure, the controller may specify one of the traffic speed sequences of the plurality of links as a query spatio-temporal point, may specify the rest of the traffic speed sequences as key spatio-temporal points, may determine similarities with the key spatio-temporal points with respect to the query spatio-temporal point, may assign weights corresponding to the similarities to key spatio-temporal points corresponding to the similarities, and may determine the result of embedding the query spatio-temporal point based on the key spatio-temporal points to which the weights are assigned, as an embedding process.

In an embodiment of the present disclosure, the controller may repeatedly perform the embedding process while changing the query spatio-temporal point.

In an embodiment of the present disclosure, the controller may multiply the key spatio-temporal points corresponding to the similarities by the weights corresponding to the similarities.

In an embodiment of the present disclosure, the controller may predict traffic speed sequences of n links for one hour in the future for traffic speed sequences of n links for one hour in the past.

In an embodiment of the present disclosure, the controller may predict the future traffic speed of the target link based on a spatio-temporal graph attention (ST-GAT) model, training of which is completed.

In an embodiment of the present disclosure, the controller may train the ST-GAT model based on an error between the predicted future traffic speed of the target link and a real traffic speed of the target link.

According to another aspect of the present disclosure, a method for predicting a traffic speed may include receiving, by an input device, traffic speed sequences of a plurality of links and detecting, by a controller, a spatio-temporal relationship between traffic speeds of the plurality of links and predicting, by the controller, a future traffic speed of a target link based on the spatio-temporal relationship between the traffic speeds of the plurality of links.

In an embodiment of the present disclosure, the predicting of the future traffic speed of the target link may include extracting features of the traffic speeds of the plurality of links, classifying the features of the traffic speeds of the plurality of links for each link, and predicting the future traffic speed of the target link based on the features of the traffic speeds, the features being classified for each link.

In an embodiment of the present disclosure, the predicting of the future traffic speed of the target link based on the features of the traffic speeds, the features being classified for each link, may include inputting the features of the traffic speeds, the features being classified for each link, to a fully connected (FC) layer corresponding to each link and predicting a future traffic speed sequence of each link.

In an embodiment of the present disclosure, the extracting of the features of the traffic speeds of the plurality of links may include specifying one of the traffic speed sequences of the plurality of links as a query spatio-temporal point and specifying the rest of the traffic speed sequences as key spatio-temporal points, determining similarities with the key spatio-temporal points with respect to the query spatio-temporal point, assigning weights corresponding to the similarities to key spatio-temporal points corresponding to the similarities, and determining the result of embedding the query spatio-temporal point based on the key spatio-temporal points to which the weights are assigned.

In an embodiment of the present disclosure, the extracting of the features of the traffic speeds of the plurality of links may include sequentially and repeatedly performing the specifying, the determining, the assigning, and the determining, while changing the query spatio-temporal point.

In an embodiment of the present disclosure, the assigning may include multiplying the key spatio-temporal points corresponding to the similarities by the weights corresponding to the similarities.

In an embodiment of the present disclosure, the predicting of the future traffic speed of the target link may include predicting traffic speed sequences of n links for one hour in the future for traffic speed sequences of n links for one hour in the past.

In an embodiment of the present disclosure, the predicting of the future traffic speed of the target link may include predicting the future traffic speed of the target link based on a spatio-temporal graph attention (ST-GAT) model, training of which is completed.

In an embodiment of the present disclosure, the predicting of the future traffic speed of the target link may further include training the ST-GAT model based on an error between the predicted future traffic speed of the target link and a real traffic speed of the target link.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for predicting a traffic speed according to an embodiment of the present disclosure;

FIG. 2A is a drawing illustrating a spatio-temporal relationship with a traffic speed of each of the remaining links with respect to a traffic speed of a first link, which is detected in a first time zone by a controller provided in an apparatus for predicting a traffic speed according to an embodiment of the present disclosure;

FIG. 2B is a drawing illustrating a spatio-temporal relationship with a traffic speed of each of the remaining links with respect to a traffic speed of a first link, which is detected in a second time zone by a controller provided in an apparatus for predicting a traffic speed according to an embodiment of the present disclosure;

FIG. 2C is a drawing illustrating a spatio-temporal relationship with a traffic speed of each of the remaining links with respect to a traffic speed of a first link, which is detected in a third time zone by a controller provided in an apparatus for predicting a traffic speed according to an embodiment of the present disclosure;

FIG. 3A is a drawing illustrating a spatio-temporal relationship with a traffic speed of each of the remaining links with respect to a traffic speed of a second link, which is detected in a first time zone by a controller provided in an apparatus for predicting a traffic speed according to an embodiment of the present disclosure;

FIG. 3B is a drawing illustrating a spatio-temporal relationship with a traffic speed of each of the remaining links with respect to a traffic speed of a second link, which is detected in a second time zone by a controller provided in an apparatus for predicting a traffic speed according to an embodiment of the present disclosure;

FIG. 3C is a drawing illustrating a spatio-temporal relationship with a traffic speed of each of the remaining links with respect to a traffic speed of a second link, which is detected in a third time zone by a controller provided in an apparatus for predicting a traffic speed according to an embodiment of the present disclosure;

FIG. 4 is a drawing illustrating a structure of a prediction model provided in an apparatus for predicting a traffic speed according to an embodiment of the present disclosure;

FIG. 5 is a drawing of a detailed structure of an embedding block in a prediction model provided in an apparatus for predicting a traffic speed according to an embodiment of the present disclosure;

FIG. 6 is a drawing of a detailed structure of a prediction block in a prediction model provided in an apparatus for predicting a traffic speed according to an embodiment of the present disclosure;

FIG. 7A is a drawing of an example indicating a qualitative analysis of performance of an apparatus for predicting a traffic speed according to an embodiment of the present disclosure;

FIG. 7B is a drawing of another example indicating a qualitative analysis of performance of an apparatus for predicting a traffic speed according to an embodiment of the present disclosure;

FIG. 7C is a drawing of another example indicating a qualitative analysis of performance of an apparatus for predicting a traffic speed according to an embodiment of the present disclosure;

FIG. 7D is a drawing of another example indicating a qualitative analysis of performance of an apparatus for predicting a traffic speed according to an embodiment of the present disclosure;

FIG. 8 is a drawing of an example indicating a quantitative analysis of performance of an apparatus for predicting a traffic speed according to an embodiment of the present disclosure;

FIG. 9 is a flowchart illustrating a method for predicting a traffic speed according to an embodiment of the present disclosure; and

FIG. 10 is a block diagram illustrating a computing system for executing a method for predicting a traffic speed according to an embodiment of the present disclosure.

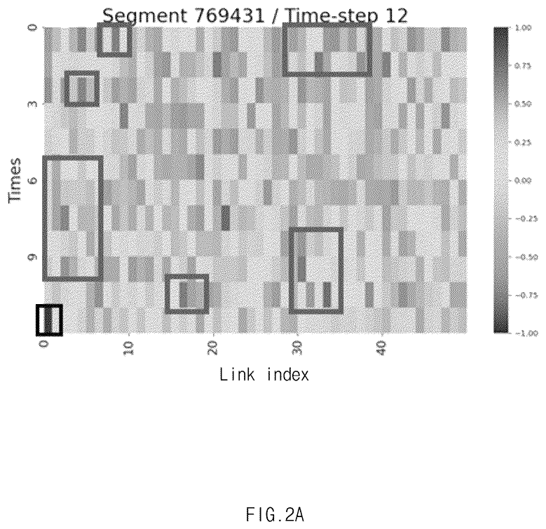

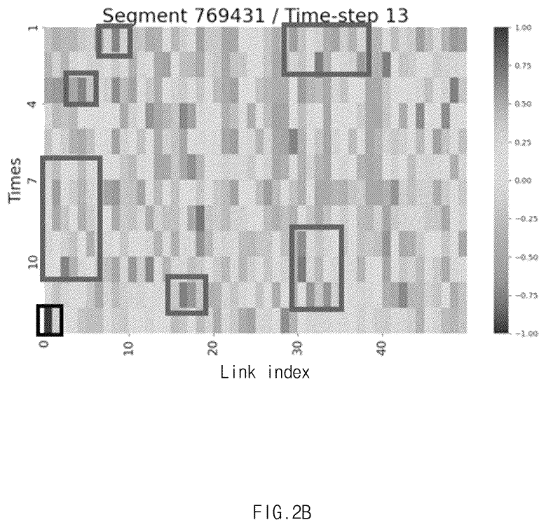

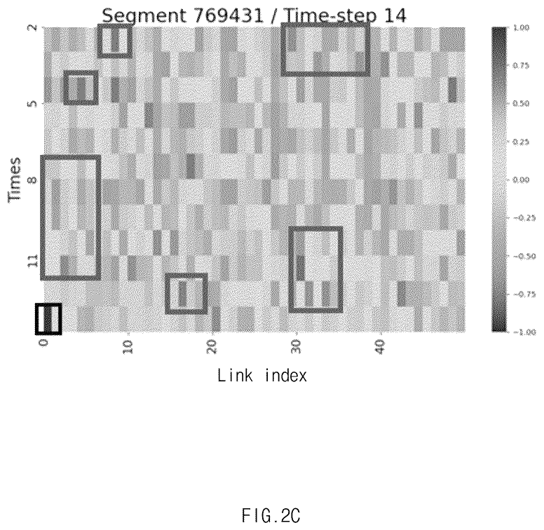

Note: FIGS. 2A, 2B, 2C, 3A, 3B, 3C, 7A, 7B, 7C, and 7D were published in color in the Korean priority document KR 10-2022-0130688. The color versions can be found in that document, which has been incorporated by reference.

### DETAILED DESCRIPTION OF ILLUSTRATIVE EMBODIMENTS

Hereinafter, some embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence, or order of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

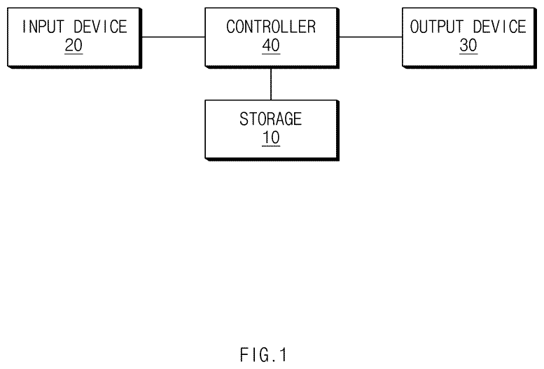

FIG. 1 is a block diagram illustrating a configuration of an apparatus for predicting a traffic speed according to an embodiment of the present disclosure.

As shown in FIG. 1, the apparatus for predicting the traffic speed according to an embodiment of the present disclosure may include storage 10, an input device 20, an output device 30, and a controller 40. In this case, the respective components may be combined into one component and some components may be omitted, depending on a manner which executes the apparatus for predicting the traffic speed according to an embodiment of the present disclosure.

Seeing the respective components, first of all, the storage 10 may store various logic, algorithms, and programs required in a process of collecting historical traffic speed sequences of a plurality of links, detecting a spatio-temporal relationship between traffic speeds of the plurality of links, and predicting a future traffic speed of a target link based on the spatio-temporal relationship between the traffic speeds of the plurality of links. Herein, the link may be a predetermined section on the road, which includes a surrounding link as well as a target link. A traffic speed of the link refers to a value obtained by dividing a length of the link by a passing time (i.e., a time taken for a vehicle to pass through the link).

The storage 10 may store a spatio-temporal graph attention (ST-GAT) model, the training of which is completed, as a traffic speed prediction model.

The storage 10 may include at least one type of storage medium such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, or an optical disk.

The input device 20 may receive historical traffic speed sequences of a plurality of links.

The output device 30 may output a traffic speed of the target link, which is predicted by the controller 40, as an image or a voice. To this end, the output device 30 may include a display module and a sound output module.

Such a display module may display (or output) information processed by a multimedia system for vehicle. For example, when the multimedia system for vehicle is in a navigation mode, the display module may display a map associated with a current location, a destination, a route, or the like in conjunction with driving of the vehicle and may display a user interface (UI) or a graphic user interface (GUI) associated with a speed, a direction, a distance indication, or the like. When the multimedia system for vehicle is in a black box mode or an image capture mode, the display module may display a captured image, a UI, or a GUI.

Furthermore, the display module may include at least one of a liquid crystal display (LCD), a thin film transistor-LCD (TFT-LCD), an organic light-emitting diode (OLED) display, a flexible display, or a three-dimensional (3D) display.

When the display module and the touch sensor make up a mutual layer structure (hereinafter referred to as a “touch screen”), the display module may be used as an input device other than an output device.

The sound output module may output audio data in a multimedia file playback mode or a broadcasting receiving mode or may output audio data stored in a memory. The sound output module may output an acoustic signal associated with a function (e.g., a warning sound, a notification sound, a route guidance voice, or the like) performed by the multimedia system for vehicle. Such a sound output module may include a receiver, a speaker, a buzzer, or the like.

The controller 40 may perform the overall control such that respective components may normally perform their own functions. Such a controller 40 may be implemented in the form of hardware, may be implemented in the form of software, or may be implemented in the form of a combination thereof. Preferably, the controller 40 may be implemented as, but not limited to, a microprocessor.

Particularly, the controller 40 may perform a variety of control required in a process of collecting historical traffic speed sequences of a plurality of links, detecting a spatio-temporal relationship between traffic speeds of the plurality of links, and predicting a future traffic speed of a target link based on the spatio-temporal relationship between the traffic speeds of the plurality of links.

Furthermore, the controller 40 may predict the future traffic speed of the target link with regard to temporal causality between a traffic speed of the target link and a traffic speed of a surrounding link as well as a relationship between the target link and the surrounding link.

Furthermore, the controller 40 may predict the traffic speed of the traffic speed based on the ST_GAT model.

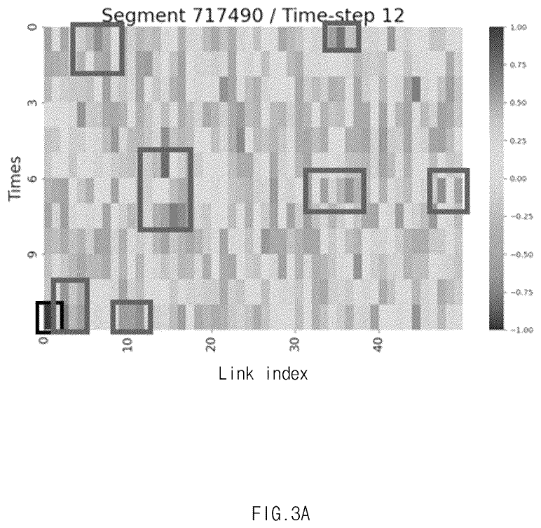

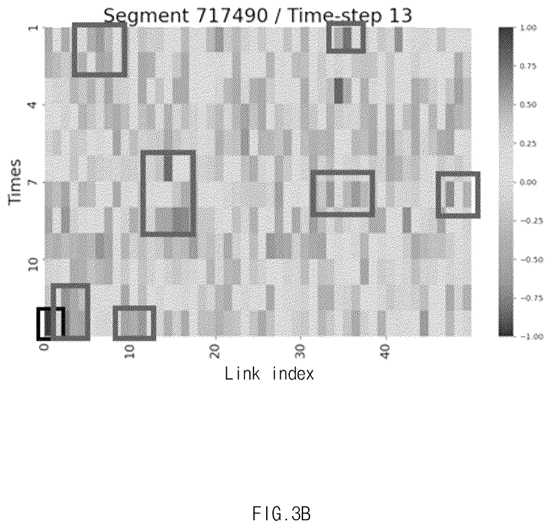

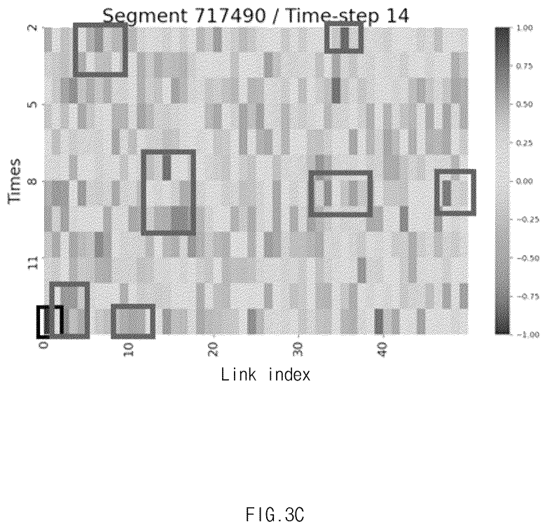

Hereinafter, a description will be given of a spatio-temporal relationship between traffic speeds of links with reference to FIGS. 2A to 3C.

FIG. 2A is a drawing illustrating a spatio-temporal relationship with a traffic speed of each of the remaining links with respect to a traffic speed of a first link, which is detected in a first time zone by a controller provided in an apparatus for predicting a traffic speed according to an embodiment of the present disclosure. In FIG. 2A, the vertical axis indicates time, and the horizontal axis indicates the index of each link.

FIG. 2B is a drawing illustrating a spatio-temporal relationship with a traffic speed of each of the remaining links with respect to a traffic speed of a first link, which is detected in a second time zone by a controller provided in an apparatus for predicting a traffic speed according to an embodiment of the present disclosure. In FIG. 2B, the vertical axis indicates time, and the horizontal axis indicates the index of each link.

FIG. 2C is a drawing illustrating a spatio-temporal relationship with a traffic speed of each of the remaining links with respect to a traffic speed of a first link, which is detected in a third time zone by a controller provided in an apparatus for predicting a traffic speed according to an embodiment of the present disclosure. In FIG. 2C, the vertical axis indicates time, and the horizontal axis indicates the index of each link.

Comparing areas displayed with boxes in the spatio-temporal relationship in the first time zone (e.g., from 7:05 a.m. to 8:05 a.m.) shown in FIG. 2A, areas displayed with boxes in the spatio-temporal relationship in the second time zone (e.g., from 8:05 a.m. to 9:05 a.m.) shown in FIG. 2B, and areas displayed with boxes in the spatio-temporal relationship in the third time zone (e.g., from 9:05 a.m. to 10:05 a.m.) shown in FIG. 2C, it may be seen that a certain pattern is represented. In other words, it may be seen that the certain pattern is represented in the spatio-temporal relationship with the traffic speed of each of the remaining links with respect to the detected traffic speed of the first link.

FIG. 3A is a drawing illustrating a spatio-temporal relationship with a traffic speed of each of the remaining links with respect to a traffic speed of a second link, which is detected in a first time zone by a controller provided in an apparatus for predicting a traffic speed according to an embodiment of the present disclosure. In FIG. 3A, the vertical axis indicates time, and the horizontal axis indicates the index of each link.

FIG. 3B is a drawing illustrating a spatio-temporal relationship with a traffic speed of each of the remaining links with respect to a traffic speed of a second link, which is detected in a second time zone by a controller provided in an apparatus for predicting a traffic speed according to an embodiment of the present disclosure. In FIG. 3B, the vertical axis indicates time, and the horizontal axis indicates the index of each link.

FIG. 3C is a drawing illustrating a spatio-temporal relationship with a traffic speed of each of the remaining links with respect to a traffic speed of a second link, which is detected in a third time zone by a controller provided in an apparatus for predicting a traffic speed according to an embodiment of the present disclosure. In FIG. 3C, the vertical axis indicates time, and the horizontal axis indicates the index of each link.

Comparing areas displayed with boxes in the spatio-temporal relationship in the first time zone (e.g., from 7:05 a.m. to 8:05 a.m.) shown in FIG. 3A, areas displayed with boxes in the spatio-temporal relationship in the second time zone (e.g., from 8:05 a.m. to 9:05 a.m.) shown in FIG. 3B, and areas displayed with boxes in the spatio-temporal relationship in the third time zone (e.g., from 9:05 a.m. to 10:05 a.m.) shown in FIG. 3C, it may be seen that a certain pattern is represented. In other words, it may be seen that the certain pattern is represented in the spatio-temporal relationship with the traffic speed of each of the remaining links with respect to the detected traffic speed of the second link.

The spatio-temporal relationship with the traffic speed of each of the remaining links with respect to the traffic speed of the first link, which is detected for each time zone, and the spatio-temporal relationship with the traffic speed of each of the remaining links with respect to the traffic speed of the second link, which is detected for each time zone, are described as an example in an embodiment of the present disclosure. However, it is identified that the certain pattern is also represented with respect to third to n links.

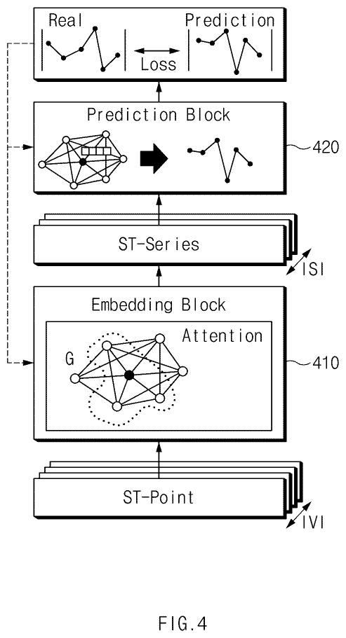

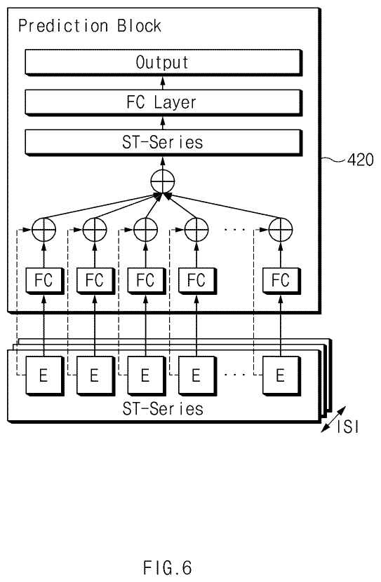

Hereinafter, the operation of the controller 40 will be described in detail with reference to FIGS. 4 and 6.

FIG. 4 is a drawing illustrating a structure of a prediction model provided in an apparatus for predicting a traffic speed according to an embodiment of the present disclosure.

As shown in FIG. 4, the prediction model provided in the apparatus for predicting the traffic speed according to an embodiment of the present disclosure may be implemented as, for example, an ST-GAT model. Such an ST-GAT model may include an embedding block 410 and a prediction block 420.

The embedding block 410 may receive a spatio-temporal (ST) point from an input device 20 of FIG. 1. Herein, the spatio-temporal point refers to a historical traffic speed sequence of each link. For example, the spatio-temporal point may include a traffic speed at intervals of five minutes in the past for No. 1 link, a traffic speed at intervals of five minutes in the past for No. 2 link, . . . , and a traffic speed at intervals of five minutes in the past for No. n link. Thus, traffic speed sequences of N links for one hour in the past may be composed of N×12 spatio-temporal points.

As an embedding process, the embedding block 410 may specify one of historical traffic speed sequences of each link, which are received from the input device 20, as a query spatio-temporal point, may specify the rest of the historical traffic speed sequences as key spatio-temporal points, may determine similarities with the key spatio-temporal points with respect to the query spatio-temporal point, may assign weights corresponding to the similarities to the key spatio-temporal points, and may output the result of adding the key spatio-temporal points to which the weights are assigned as a feature of the query spatio-temporal point (in other words, the result of embedding).

At this time, the historical traffic speed (in other words, the spatio-temporal point) of each link should be specified as a query spatio-temporal point one by one. The embedding block 410 may perform the embedding process by the number of historical traffic speeds of each link (in other words, the number of all of spatio-temporal points). For example, when there are No. 1 spatio-temporal point, No. 2 spatio-temporal point, and No. 3 spatio-temporal point, the embedding block 410 may specify No. 1 spatio-temporal point as a query spatio-temporal point, may specify No. 2 spatio-temporal point and No. 3 spatio-temporal point as key spatio-temporal points, and may output the result of embedding No. 1 spatio-temporal point, may specify No. 2 spatio-temporal point as a query spatio-temporal point, may specify No. 1 spatio-temporal point and No. 3 spatio-temporal point as key spatio-temporal points, may output the result of embedding No. 2 spatio-temporal point, and may specify No. 3 spatio-temporal point as a query spatio-temporal point, may specify No. 1 spatio-temporal point and No. 2 spatio-temporal point as key spatio-temporal points, and may output the result of embedding No. 3 spatio-temporal point. Such an embedding output process may be performed in parallel.

Furthermore, for the process of determining the similarities, for example, when there are No. 1 key spatio-temporal point, No. 2 key spatio-temporal point, and No. 3 key spatio-temporal point, when No. 1 key spatio-temporal point is a query spatio-temporal point, when a similarity between the query spatio-temporal point and No. 2 key spatio-temporal point is “A”, and when a similarity between the query spatio-temporal point and No. 3 key spatio-temporal point is “B”, the embedding block 410 may assign a weight A1 corresponding to “A” to No. 2 key spatio-temporal point and may assign a weight B1 corresponding to “B” to No. 3 key spatio-temporal point. At this time, when the similarity A is greater than the similarity B, the weight A1 has a value greater than the weight B1.

A controller 40 of FIG. 1 may classify “ST-Series” received from the embedding block 410 for each link and may input the result of embedding a spatio-temporal point for each link to the prediction block 420. At this time, “ST-Series” indicates the result of embedding the historical traffic speed sequence of each link, that is, the result of embedding each spatio-temporal point.

The prediction block 420 may input the result of embedding the spatio-temporal point for each link to a fully connected (FC) layer corresponding to each link to predict a future traffic speed sequence of each link. At this time, the prediction block 420 may predict traffic speed sequences of n links for one hour in the future for traffic speed sequences of n links for one hour in the past.

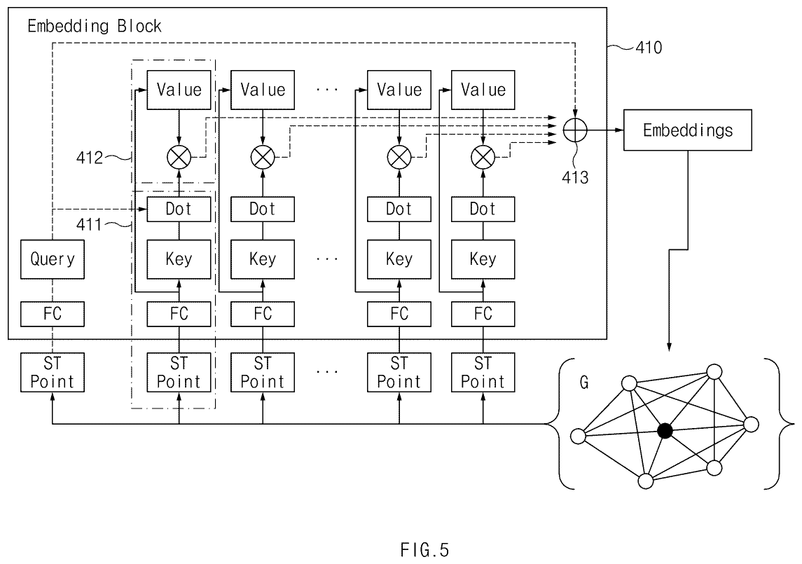

FIG. 5 is a drawing of a detailed structure of an embedding block in a prediction model provided in an apparatus for predicting a traffic speed according to an embodiment of the present disclosure.

As shown in FIG. 5, an embedding block 410 in the prediction model provided in the apparatus for predicting the traffic speed according to an embodiment of the present disclosure may include a plurality of similarity determination devices 411 and a plurality of weight assigning devices 412.

The similarity determination devices 411 may determine similarities with key spatio-temporal points with respect to a query spatio-temporal point.

The weight assigning devices 412 may assign weights corresponding to the similarities to the key spatio-temporal points. In other words, the weight assigning devices 412 may multiply the key spatio-temporal points by the weights corresponding to the similarities.

An adding device 413 may add the respective key spatio-temporal points to which the weights are assigned and may output the result as the result of embedding the query spatio-temporal point.

FIG. 6 is a drawing of a detailed structure of a prediction block in a prediction model provided in an apparatus for predicting a traffic speed according to an embodiment of the present disclosure.

As shown in FIG. 6, a prediction block 420 in the prediction model provided in the apparatus for predicting the traffic speed according to an embodiment of the present disclosure may input the result of embedding a spatio-temporal point for each link to a fully connected (FC) layer and may predict a future traffic speed sequence of each link.

The process of predicting the future traffic speed of each link may be performed in parallel. For example, the prediction block 420 may input the result of embedding a spatio-temporal point of a first link to a first FC layer to predict a future traffic speed of the first link, may input the result of embedding a spatio-temporal point of a second link to a second FC layer to predict a future traffic speed of the second link, and may input the result of embedding a spatio-temporal point of a third link to a third FC layer to predict a future traffic speed of the third link.

In addition, the prediction block 420 may convert the result of embedding a spatio-temporal point for each link using FC and “residual connection” for stable training.

Meanwhile, a controller 40 of FIG. 1 may compare the result predicted by the prediction block 420 with a real traffic speed sequence and may train the prediction block 420.

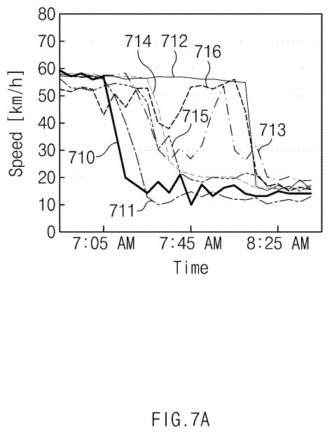

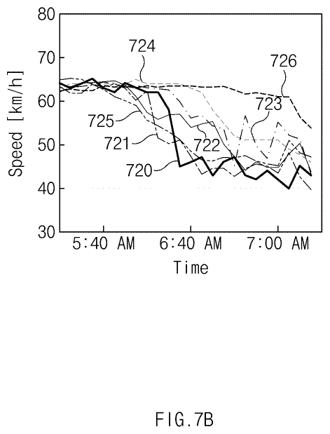

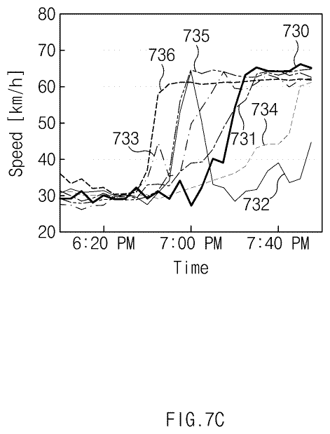

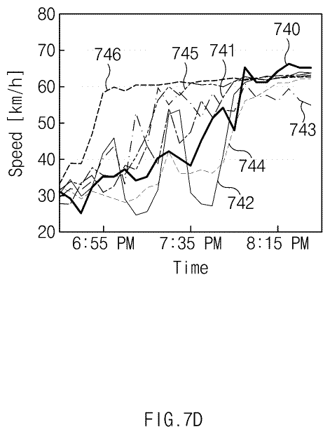

FIG. 7A is a drawing of an example indicating a qualitative analysis of performance of an apparatus for predicting a traffic speed according to an embodiment of the present disclosure.

In a graph shown in FIG. 7A, as traffic speeds of a first link predicted during morning rush hour, reference numeral 710 indicates the real traffic speed, reference numeral 711 indicates the traffic speed predicted based on the ST-GAT model according to an embodiment of the present disclosure, reference numeral 712 indicates the traffic speed predicted based on the spatial-temporal synchronous graph convolutional network (STSGCN) model, reference numeral 713 indicates the traffic speed predicted based on the dynamic and multi-faceted spatio-temporal graph convolutional network (DMSTGCN) model, reference numeral 714 indicates the traffic speed predicted based on the graph multi-attention network (GMAN) model, reference numeral 715 indicates the traffic speed predicted based on the adaptive graph convolutional recurrent network (AGCRN) model, and reference numeral 716 indicates the traffic speed predicted based on the spatio-temporal graph convolutional network (STGCN) model.

It may be seen that the traffic speed 711 predicted based on the ST-GAT model according to an embodiment of the present disclosure is more similar to the real traffic speed 710 than the traffic speed 712 predicted based on the STSGCN model, the traffic speed 713 predicted based on the DMSTGCN model, the traffic speed 714 predicted based on the GMAN model, the traffic speed 715 predicted based on the AGCRN model, and the traffic speed 716 predicted based on the STGCN model.

For example, it may be seen that the traffic speed 711 around 7:25 a.m. predicted based on the ST-GAT model according to an embodiment of the present disclosure is 14 km/h and is very similar to the real traffic speed 710 around 7:25 a.m., 15 km/h, whereas the traffic speeds 712, 713, 714, 715, and 716 around 7:25 a.m. predicted based on the other models are distributed in the range of 45 km/h to 60 km/h.

FIG. 7B is a drawing of another example indicating a qualitative analysis of performance of an apparatus for predicting a traffic speed according to an embodiment of the present disclosure.

In a graph shown in FIG. 7B, as traffic speeds of a second link predicted during morning rush hour, reference numeral 720 indicates the real traffic speed, reference numeral 721 indicates the traffic speed predicted based on the ST-GAT model according to an embodiment of the present disclosure, reference numeral 722 indicates the traffic speed predicted based on the STSGCN model, reference numeral 723 indicates the traffic speed predicted based on the DMSTGCN model, reference numeral 724 indicates the traffic speed predicted based on the GMAN model, reference numeral 725 indicates the traffic speed predicted based on the AGCRN model, and reference numeral 726 indicates the traffic speed predicted based on the STGCN model.

It may be seen that the traffic speed 721 predicted based on the ST-GAT model according to an embodiment of the present disclosure is more similar to the real traffic speed 720 than the traffic speed 722 predicted based on the STSGCN model, the traffic speed 723 predicted based on the DMSTGCN model, the traffic speed 724 predicted based on the GMAN model, the traffic speed 725 predicted based on the AGCRN model, and the traffic speed 726 predicted based on the STGCN model.

For example, it may be seen that the traffic speed 721 around 6:20 a.m. predicted based on the ST-GAT model according to an embodiment of the present disclosure is 46 km/h and is very similar to the real traffic speed 720 around 7:25 a.m., 45 km/h, whereas the traffic speeds 722, 723, 724, 725, and 726 around 6:20 a.m. predicted based on the other models are distributed in the range of 55 km/h to 66 km/h.

FIG. 7C is a drawing of another example indicating a qualitative analysis of performance of an apparatus for predicting a traffic speed according to an embodiment of the present disclosure.

In a graph shown in FIG. 7C, as traffic speeds of a first link predicted during afternoon rush hour, reference numeral 730 indicates the real traffic speed, reference numeral 731 indicates the traffic speed predicted based on the ST-GAT model according to an embodiment of the present disclosure, reference numeral 732 indicates the traffic speed predicted based on the STSGCN model, reference numeral 733 indicates the traffic speed predicted based on the DMSTGCN model, reference numeral 734 indicates the traffic speed predicted based on the GMAN model, reference numeral 735 indicates the traffic speed predicted based on the AGCRN model, and reference numeral 736 indicates the traffic speed predicted based on the STGCN model.

It may be seen that the traffic speed 731 predicted based on the ST-GAT model according to an embodiment of the present disclosure is more similar to the real traffic speed 730 than the traffic speed 732 predicted based on the STSGCN model, the traffic speed 733 predicted based on the DMSTGCN model, the traffic speed 734 predicted based on the GMAN model, the traffic speed 735 predicted based on the AGCRN model, and the traffic speed 736 predicted based on the STGCN model.

For example, it may be seen that the traffic speed 731 around 7:10 p.m. predicted based on the ST-GAT model according to an embodiment of the present disclosure is 42 km/h and is very similar to the real traffic speed 730 around 7:10 p.m., 40 km/h, whereas the traffic speed 734 around 7:10 p.m. predicted based on the GMAN model is 35 km/h, the traffic speed 735 around 7:10 p.m. predicted based on the AGCRN model is 33 km/h, and the traffic speeds 732, 733, and 736 around 7:10 p.m. predicted based on the other models are distributed in the range of 60 km/h to 65 km/h.

FIG. 7D is a drawing of another example indicating a qualitative analysis of performance of an apparatus for predicting a traffic speed according to an embodiment of the present disclosure.

In a graph shown in FIG. 7D, as traffic speeds of a second link predicted during afternoon rush hour, reference numeral 740 indicates the real traffic speed, reference numeral 741 indicates the traffic speed predicted based on the ST-GAT model according to an embodiment of the present disclosure, reference numeral 742 indicates the traffic speed predicted based on the STSGCN model, reference numeral 743 indicates the traffic speed predicted based on the DMSTGCN model, reference numeral 744 indicates the traffic speed predicted based on the GMAN model, reference numeral 745 indicates the traffic speed predicted based on the AGCRN model, and reference numeral 746 indicates the traffic speed predicted based on the STGCN model.

It may be seen that the traffic speed 741 predicted based on the ST-GAT model according to an embodiment of the present disclosure is more similar to the real traffic speed 740 than the traffic speed 742 predicted based on the STSGCN model, the traffic speed 743 predicted based on the DMSTGCN model, the traffic speed 744 predicted based on the GMAN model, the traffic speed 745 predicted based on the AGCRN model, and the traffic speed 746 predicted based on the STGCN model.

For example, it may be seen that the traffic speed 741 around 7:43 p.m. predicted based on the ST-GAT model according to an embodiment of the present disclosure is 50 km/h and is very similar to the real traffic speed 740 around 7:43 p.m., 49 km/h, whereas the traffic speed 744 around 7:43 p.m. predicted based on the GMAN model is 37 km/h, the traffic speed 745 around 7:43 p.m. predicted based on the AGCRN model is 27 km/h, and the traffic speeds 742, 743, and 746 around 7:43 p.m. predicted based on the other models are distributed in the range of 58 km/h to 61 km/h.

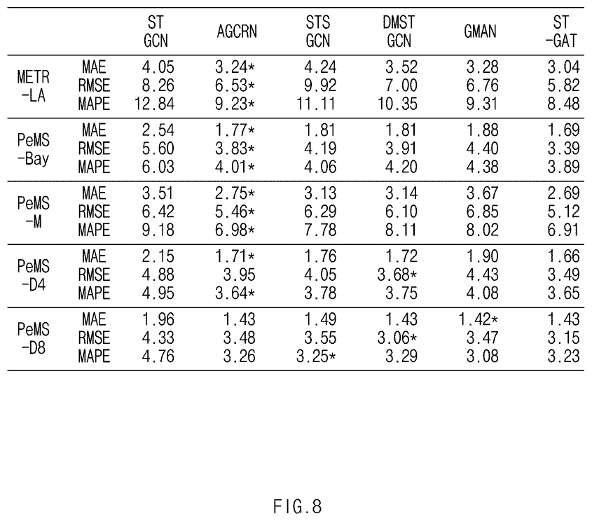

FIG. 8 is a drawing of an example indicating a quantitative analysis of performance of an apparatus for predicting a traffic speed according to an embodiment of the present disclosure.

As shown in FIG. 8, a table may include an error between the traffic speed predicted based on the STSGCN model and the real traffic speed, an error between the traffic speed predicted based on the AGCRN model and the real traffic speed, an error between the traffic speed predicted based on the STGCN model and the real traffic speed, an error between the traffic speed predicted based on the DMSTGCN model and the real traffic speed, an error between the traffic speed predicted based on the GMAN model and the real traffic speed, and an error between the traffic speed predicted based on the ST-GAT model according to an embodiment of the present disclosure and the real traffic speed. At this time, the error may be calculated a mean absolute error (MAE) scheme, a root mean square error (RMSE) scheme, or a mean absolute percentage error (MAPE) scheme. Herein, each of “METR-LA,” “PeMS-Bay,” “PeMs-M,” “PeMs-D4,” and “PeMs-D8” refers to a public real-world dataset.

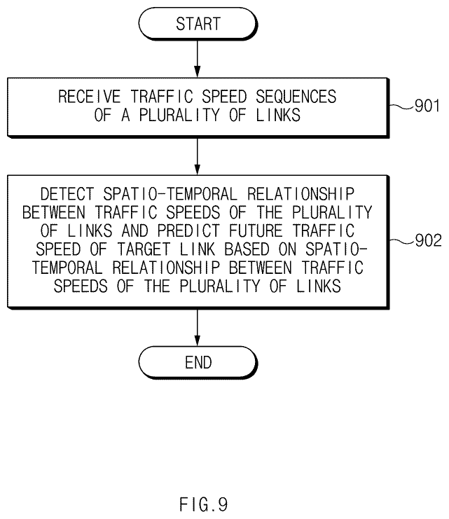

FIG. 9 is a flowchart illustrating a method for predicting a traffic speed according to an embodiment of the present disclosure.

First of all, in operation 901, an input device 20 of FIG. 1 may receive traffic speed sequences of a plurality of links.

In operation 902, a controller 40 of FIG. 1 may detect a spatio-temporal relationship between traffic speeds of the plurality of links and may predict a future traffic speed of a target link based on the spatio-temporal relationship between the traffic speeds of the plurality of links.

The predicted future traffic speed can be used to instruct a vehicle or a plurality of vehicles to proceed on routes with the optimal speeds. With this instruction, any particular vehicle can alter routes or continue on a previous route depending upon the predicted future traffic speed. In another embodiment, a central computing system (e.g., system 1000 discussed below) can instruct a plurality of vehicles to maintain optimal traffic flow along a number of routes. In this manner, the method can be used for congestion control or vehicle navigation routing, as but two examples.

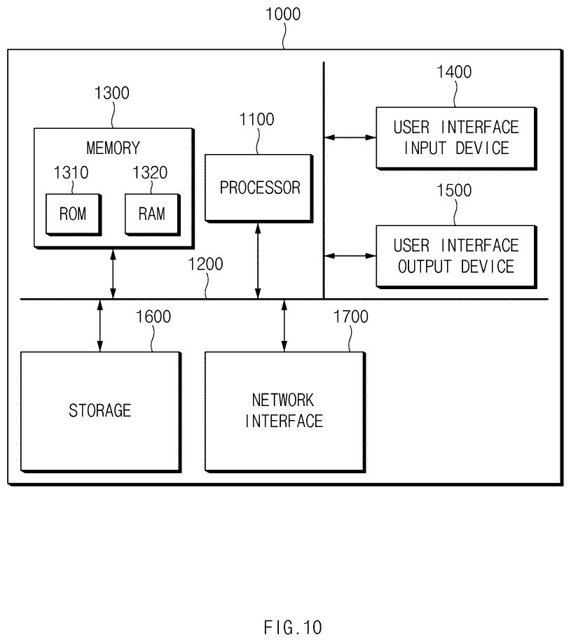

FIG. 10 is a block diagram illustrating a computing system for executing a method for predicting a traffic speed according to an embodiment of the present disclosure.

Referring to FIG. 10, the above-mentioned method for predicting the traffic speed according to an embodiment of the present disclosure may be implemented by means of the computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a SSD (Solid State Drive), a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus for predicting the traffic speed and the method thereof according to an embodiment of the present disclosure may be provided to collect historical traffic speed sequences of a plurality of links, detect a spatio-temporal relationship between traffic speeds of the plurality of links, and predict a future traffic speed of a target link based on the spatio-temporal relationship between the traffic speeds of the plurality of links, thus predicting the traffic speed of the target link to have high accuracy.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. An apparatus for predicting a traffic speed, the apparatus comprising:
an input device configured to receive traffic speed sequences of a plurality of links; and
a controller configured to detect a spatio-temporal relationship between traffic speeds of the plurality of links and predict a future traffic speed of a target link based on the spatio-temporal relationship between the traffic speeds of the plurality of links.

2. The apparatus of claim 1, wherein the controller is configured to:
extract features of the traffic speeds of the plurality of links;
classify the features of the traffic speeds of the plurality of links for each link; and
predict the future traffic speed of the target link based on the classified features of the traffic speeds.

3. The apparatus of claim 2, wherein the controller is configured to input the classified features of the traffic speeds to a fully connected (FC) layer corresponding to each link and predict a future traffic speed sequence of each link.

4. The apparatus of claim 2, wherein the controller is configured to:
specify one of the traffic speed sequences of the plurality of links as a query spatio-temporal point;
specify the rest of the traffic speed sequences as key spatio-temporal points;
determine similarities between the key spatio-temporal points and the query spatio-temporal point;
assign weights corresponding to the similarities to key spatio-temporal points corresponding to the similarities; and
determine the result of embedding the query spatio-temporal point based on the key spatio-temporal points to which the weights are assigned, as an embedding process.

5. The apparatus of claim 4, wherein the controller is configured to repeatedly perform the embedding process while changing the query spatio-temporal point.

6. The apparatus of claim 4, wherein the controller is configured to multiply the key spatio-temporal points corresponding to the similarities by the weights corresponding to the similarities.

7. The apparatus of claim 1, wherein the controller is configured to predict traffic speed sequences of n links for one hour in the future for traffic speed sequences of n links for one hour in the past.

8. The apparatus of claim 1, wherein the controller is configured to predict the future traffic speed of the target link based on a spatio-temporal graph attention (ST-GAT) model, training of which is completed.

9. The apparatus of claim 8, wherein the controller is configured to train the ST-GAT model based on an error between the predicted future traffic speed of the target link and a real traffic speed of the target link.

10. A method for predicting a traffic speed, the method comprising:
receiving, by an input device, traffic speed sequences of a plurality of links;
detecting, by a controller, a spatio-temporal relationship between traffic speeds of the plurality of links; and
predicting, by the controller, a future traffic speed of a target link based on the spatio-temporal relationship between the traffic speeds of the plurality of links.

11. The method of claim 10, wherein predicting the future traffic speed of the target link comprises:
extracting features of the traffic speeds of the plurality of links;
classifying the features of the traffic speeds of the plurality of links for each link; and
predicting the future traffic speed of the target link based on the classified features of the traffic speeds.

12. The method of claim 11, wherein predicting the future traffic speed of the target link based on the classified features of the traffic speeds comprises inputting the classified features of the traffic speeds to a fully connected (FC) layer corresponding to each link and predicting a future traffic speed sequence of each link.

13. The method of claim 11, wherein extracting the features of the traffic speeds of the plurality of links comprises:
specifying one of the traffic speed sequences of the plurality of links as a query spatio-temporal point and specifying the rest of the traffic speed sequences as key spatio-temporal points;
determining similarities between the key spatio-temporal points and the query spatio-temporal point;
assigning weights corresponding to the similarities to key spatio-temporal points corresponding to the similarities; and
determining the result of embedding the query spatio-temporal point based on the key spatio-temporal points to which the weights are assigned.

14. The method of claim 13, wherein extracting the features of the traffic speeds of the plurality of links comprises sequentially and repeatedly performing the specifying, the determining of similarities, the assigning, and the determining of the results of embedding, while changing the query spatio-temporal point.

15. The method of claim 13, wherein the assigning comprises multiplying the key spatio-temporal points corresponding to the similarities by the weights corresponding to the similarities.

16. The method of claim 10, wherein the predicting of the future traffic speed of the target link comprises predicting traffic speed sequences of n links for one hour in the future for traffic speed sequences of n links for one hour in the past.

17. The method of claim 10, wherein the predicting of the future traffic speed of the target link comprises predicting the future traffic speed of the target link based on a spatio-temporal graph attention (ST-GAT) model, training of which is completed.

18. The method of claim 17, wherein predicting the future traffic speed of the target link further comprises training the ST-GAT model based on an error between the predicted future traffic speed of the target link and a real traffic speed of the target link.

19. The method of claim 10, further comprising:
generating a navigation route based on the predicted future traffic speed; and
providing the navigation route to a vehicle so that the vehicle can travel along the provided navigation route.

20. The method of claim 19, further comprising receiving the navigation route at the vehicle and operating the vehicle to travel according to the navigation route that was generated based on the predicted future traffic speed.
